(19) United States
(12) Patent Application Publication
(10) Pub. No.: US 2026/0303717 A1
(43) Pub. Date: Oct. 1, 2026

(54) FOLDABLE ELECTRONIC DEVICE

(71) Applicant: SYNCMOLD ENTERPRISE CORP., New Taipei City (TW)

(72) Inventors: Chun-Hao Huang, New Taipei City (TW); Chien-Cheng Yeh, New Taipei City (TW)

(21) Appl. No.: 19/462,065

(22) Filed: Jan. 28, 2026

Related U.S. Application Data
(60) Provisional application No. 63/779,610, filed on Mar. 28, 2025.

(30) Foreign Application Priority Data
Nov. 14, 2025 (TW) 114144540

(51) Int. Cl. H04M 1/02

(52) U.S. Cl. CPC H04M 1/022; H04M 1/0268

(57) ABSTRACT

A foldable electronic device includes a central base, a pivot module, wing members, transmission members, panel bodies, drop plates, connecting members, at least one pushing block, a synchronization module, an elastic module and a flexible screen. The pivot module is disposed on the central base. The wing members are pivotally rotated relative to the central base. The transmission members are connected to the pivot module, the synchronization module and the elastic module. The panel bodies are connected to the wing members. The drop plates are connected to the panel bodies. The connecting members are connected to the transmission members and the drop plates. The pushing block is disposed on the central base and pushes the wing members. The synchronization module drives the transmission members to rotate synchronously and reversely. The flexible screen is disposed on the central base, the panel bodies and the drop plates, and includes a bendable region.

### CROSS-REFERENCE TO RELATED APPLICATIONS

This application claims the benefit of U.S. Provisional Application Serial No. 63/779,610 filed on March 28, 2025, and the benefit of Taiwan Patent Application Serial No. 114144540 filed on November 14, 2025. The entirety of each Application is incorporated herein by reference.

### BACKGROUND

### 1. Technical Field

The present disclosure relates to a foldable electronic device, and more particularly, to a foldable electronic device having a flexible screen.

### 2. Description of Related Art

Flexible screens have been widely applied to smartphones and tablet computers, and are typically supported by a linkage structure. In addition to providing support, the linkage structure can also offer the necessary accommodation space for a bendable region of the flexible screen. For example, corresponding arc-shaped sliders and arc-shaped rails are used to control the size and angle of the accommodation space for the bendable region. However, in existing linkage structures, a gap remains between the arc-shaped slider and the arc-shaped rail during the folding process. This gap may cause the arc-shaped slider to disengage from the arc-shaped rail after folding, thereby being stuck outside the arc-shaped rail, which makes the linkage structure is unable to be restored in the reverse direction.

### SUMMARY

The present disclosure provides a foldable electronic device, which comprises: a central base including a body portion, a track portion, at least one first inner arc-shaped slider and at least one second inner arc-shaped slider, wherein the track portion is formed by extending outward from the body portion, and the first inner arc-shaped slider and the second inner arc-shaped slider are spaced apart from each other and are formed on the body portion; a pivot module disposed on the central base and including a first shaft and a second shaft respectively and pivotally connected to the body portion; a first wing member including at least one first inner arc-shaped slideway and a first pivot joint portion, wherein the first inner arc-shaped slider is slidably disposed on the first inner arc-shaped slideway, whereby the first wing member is able to pivotally rotate relative to the body portion about a first inner virtual axis as a center; a first transmission member sleeved on the first shaft and including at least one first middle arc-shaped slider; a first panel body including a first carrying member, wherein the first carrying member has a first pivoting portion and a first straight slide groove, and the first pivoting portion is pivotally connected to the first pivot joint portion and jointly defines a first outer virtual axis, whereby the first carrying member is able to rotate relative to the first wing member about the first outer virtual axis, and the first transmission member is slidably disposed in the first straight slide groove, whereby the first carrying member is able to linearly slide relative to the first transmission member; a first drop plate pivotally carried on the first carrying member; a first connecting member pivotally connected to the first drop plate and including at least one first middle arc-shaped slide groove, wherein the first middle arc-shaped slider is slidably disposed in the first middle arc-shaped slide groove; a second wing member including at least one second inner arc-shaped slideway and a second pivot joint portion, wherein the second inner arc-shaped slider is slidably disposed on the second inner arc-shaped slideway, whereby the second wing member is able to pivotally rotate relative to the body portion about a second inner virtual axis as a center; a second transmission member sleeved on the second shaft and including at least one second middle arc-shaped slider; a second panel body including a second carrying member, wherein the second carrying member has a second pivoting portion and a second straight slide groove, and the second pivoting portion is pivotally connected to the second pivot joint portion and jointly defines a second outer virtual axis, whereby the second carrying member is able to rotate relative to the second wing member about the second outer virtual axis, and the second transmission member is slidably disposed in the second straight slide groove, whereby the second carrying member is able to linearly slide relative to the second transmission member; a second drop plate pivotally carried on the second carrying member; a second connecting member pivotally connected to the second drop plate and including at least one second middle arc-shaped slide groove, wherein the second middle arc-shaped slider is slidably disposed in the second middle arc-shaped slide groove; at least one pushing block disposed on the body portion, spaced apart from the first inner arc-shaped slider and the second inner arc-shaped slider, and contacting and pushing the first wing member and the second wing member to respectively approach the first inner arc-shaped slider and the second inner arc-shaped slider; a synchronization module including a synchronization slider body slidably disposed between the first transmission member and the second transmission member, wherein the first transmission member and the second transmission member are respectively connected to the synchronization slider body, and when the synchronization slider body slides, the synchronization slider body is able to respectively drive the first transmission member and the second transmission member to rotate synchronously and reversely; an elastic module including a pushing member, wherein the pushing member is slidably sleeved on the first shaft and the second shaft and is movably engaged with the first transmission member and the second transmission member; and a flexible screen disposed on the first panel body, the second panel body, the first drop plate, the second drop plate and the central base, and the flexible screen including a bendable region, wherein the first panel body and the second panel body are able to transform between an unfolded state and a folded state, wherein when the first panel body and the second panel body are in the unfolded state, the flexible screen is flattened, and the first drop plate, the second drop plate and the central base jointly support the bendable region, and wherein when the first panel body and the second panel body are in the folded state, the bendable region of the flexible screen is bent, the first drop plate, the second drop plate and the central base jointly define an accommodation space to accommodate the bendable region, and the first wing member and the second wing member pushed by the pushing block are not able to separate from the first inner arc-shaped slider and the second inner arc-shaped slider.

In the aforementioned foldable electronic device, the pushing block includes a main portion, a first extending portion and a second extending portion, and wherein the main portion is disposed between the first wing member and the second wing member, the first extending portion and the second extending portion respectively extend outward from opposite sides of the main portion and are bent, the first extending portion is sandwiched between the first wing member and the central base, and the second extending portion is sandwiched between the second wing member and the central base.

In the aforementioned foldable electronic device, the first wing member further includes at least one first inner arc-shaped protrusion, and the first inner arc-shaped slideway is surrounded and defined by the first inner arc-shaped protrusion, wherein the second wing member further includes at least one second inner arc-shaped protrusion, and the second inner arc-shaped slideway is surrounded and defined by the second inner arc-shaped protrusion, wherein the first extending portion and the second extending portion respectively abut against and push the first inner arc-shaped protrusion and the second inner arc-shaped protrusion, so that the first wing member and the second wing member respectively approach the first inner arc-shaped slider and the second inner arc-shaped slider, and wherein the pushing block is made of an elastic material.

In the aforementioned foldable electronic device, the first drop plate includes a first outer arc-shaped slider and a first insert rod, the first carrying member further has a first outer arc-shaped slideway, the first outer arc-shaped slider is slidably disposed on the first outer arc-shaped slideway, the first connecting member further includes a first pivot portion, and the first insert rod passes through the first pivot portion, wherein the second drop plate includes a second outer arc-shaped slider and a second insert rod, the second carrying member further includes a second outer arc-shaped slideway, the second outer arc-shaped slider is slidably disposed on the second outer arc-shaped slideway, the second connecting member further includes a second pivot portion, and the second insert rod passes through the second pivot portion, and wherein the central base further includes an engaging block, external shapes of the main portion, the first extending portion and the second extending portion of the pushing block collectively match an external shape of the engaging block, so that the pushing block is engaged with the engaging block.

In the aforementioned foldable electronic device, the first shaft extends along a first axis, the first straight slide groove extends substantially perpendicular to the first axis, the first transmission member further includes a first bending plate and a first straight slider, the first bending plate extends along a radial direction of the first axis and is bent, the first straight slider extends outward from the first bending plate along the radial direction of the first axis and is slidably disposed in the first straight slide groove, and the first middle arc-shaped slider is formed on the first straight slider, and wherein the second shaft extends along a second axis, the second straight slide groove extends substantially perpendicular to the second axis, the second transmission member further includes a second bending plate and a second straight slider, the second bending plate extends along a radial direction of the second axis and is bent, the second straight slider extends outward from the second bending plate along the radial direction of the second axis and is slidably disposed in the second straight slide groove, and the second middle arc-shaped slider is formed on the second straight slider.

In the aforementioned foldable electronic device, further comprising a first elastic member and a second elastic member, wherein the first elastic member is buckled in the first straight slider and is away from the first bending plate, the second elastic member is buckled in the second straight slider and is away from the second bending plate, the first carrying member further has a first convex rib, the second carrying member further has a second convex rib, wherein when the first panel body and the second panel body are in the unfolded state, the first elastic member abuts against the first convex rib, and the second elastic member abuts against the second convex rib, and wherein in a process of transforming the first panel body and the second panel body from the unfolded state to the folded state, the first elastic member is pushed and compressed by the first convex rib, crossing through and gradually moving away from the first convex rib, and the second elastic member is pushed and compressed by the second convex rib, crossing through and gradually moving away from the second convex rib.

In the aforementioned foldable electronic device, the first transmission member further includes a first driving cam, the second transmission member further includes a second driving cam, and the pushing member has a first driven cam and a second driven cam, and wherein the first driving cam is slidably sleeved on the first shaft along the first axis, is connected to the first bending plate, and cooperates with the first driven cam, and the second driving cam is slidably sleeved on the second shaft along the second axis, is connected to the second bending plate, and cooperates with the second driven cam.

In the aforementioned foldable electronic device, the pivot module includes a fixed base, a first shaft hole and a second shaft hole, wherein the fixed base has a first wing portion and a second wing portion, wherein the first shaft hole is formed through the first wing portion along the first axis, and the first shaft passes through the first shaft hole, and wherein the second shaft hole is formed through the second wing portion along the second axis, and the second shaft passes through the second shaft hole.

In the aforementioned foldable electronic device, the first driven cam is sleeved on the first shaft, the second driven cam is sleeved on the second shaft, the first driving cam is mutually matched and engaged with the first driven cam, the second driving cam is mutually matched and engaged with the second driven cam, the elastic module further includes a first elastic member and a second elastic member, the first elastic member and the second elastic member are respectively sleeved on the first shaft and the second shaft, two ends of the first elastic member respectively abut against the first wing portion and the first driven cam, two ends of the second elastic member respectively abut against the second wing portion and the second driven cam, wherein when the first panel body and the second panel body are in a half-folded state between the unfolded state and the folded state, the first driving cam and the second driving cam abut against the first driven cam and the second driven cam, whereby the first elastic member and the second elastic member are compressed, and wherein when the first carrying member and the second carrying member are in the unfolded state or the folded state, the first elastic member and the second elastic member are correspondingly released.

In the aforementioned foldable electronic device, the first axis, the first inner virtual axis, the first outer virtual axis, the second axis, the second inner virtual axis and the second outer virtual axis are parallel to one another.

In the aforementioned foldable electronic device, the synchronization module further includes a first helical protrusion, a second helical protrusion, a first helical groove and a second helical groove, and wherein the first helical protrusion is matched with and accommodated in the first helical groove, and the second helical protrusion is matched with and accommodated in the second helical groove.

In the aforementioned foldable electronic device, the first helical groove is recessed and formed on the first transmission member along a first helical direction, the second helical groove is recessed and formed on the second transmission member along a second helical direction, the second helical groove corresponds to the first helical groove, and the first helical protrusion and the second helical protrusion are respectively formed on opposite side surfaces of the synchronization slider body.

In the aforementioned foldable electronic device, the first helical direction is opposite to the second helical direction.

In the aforementioned foldable electronic device, the central base further includes a housing, and the housing covers the body portion, wherein when the first panel body and the second panel body are in the unfolded state, the first drop plate and the second drop plate contact a top side of the housing, and wherein when the first panel body and the second panel body are in the folded state, the first drop plate and the second drop plate are away from the housing.

In the aforementioned foldable electronic device, the central base further includes a track groove formed through the track portion, and wherein the synchronization module further includes a limiting rib formed on the synchronization slider body, and the limiting rib is able to be slidably accommodated in the track groove.

As can be seen from the above, in the foldable electronic device of the present disclosure, via the pushing blocks abutting against the first wing member and the second wing member, a gap between a lower edge of the first inner arc-shaped sliders and an upper edge of the first inner arc-shaped protrusions is reduced and a gap between a lower edge of the second inner arc-shaped sliders and an upper edge of the second inner arc-shaped protrusions is reduced, so that when the first wing member and the second wing member are transformed to the folded state, the first inner arc-shaped sliders do not separate from the first inner arc-shaped slideways, the first inner arc-shaped protrusions do not separate from a sliding space between the first inner arc-shaped sliders and the first extending portions, the second inner arc-shaped sliders do not separate from the second inner arc-shaped slideways, and the second inner arc-shaped protrusions do not separate from a sliding space between the second inner arc-shaped sliders and the second extending portions, whereby a user can experience smooth and jam-free operation during repeated folding. Additionally, the coordinated arrangement of the first elastic member, the first convex rib, the second elastic member and the second convex rib provides the user with a tactile “snap-over” feeling during folding.

### BRIEF DESCRIPTION OF THE DRAWINGS

FIG. 1 is a schematic v

iew of a foldable electronic device according to the present disclosure in an unfolded state.

FIG. 2 is an exploded schematic view of the foldable electronic device according to the present disclosure in the unfolded state.

FIG. 3 is an exploded schematic view of the foldable electronic device according to the present disclosure.

FIG. 4 is an exploded schematic view of some components of the foldable electronic device according to the present disclosure.

FIG. 5 is an exploded schematic view of some components of the foldable electronic device according to the present disclosure.

FIG. 6 is a bottom view of a first drop plate, a first carrying member, a second drop plate and a second carrying member of the foldable electronic device according to the present disclosure.

FIG. 7 is a top view of a first transmission member, a second transmission member and a synchronization module of the foldable electronic device according to the present disclosure.

FIG. 8 is a top view of the first transmission member, the second transmission member and an elastic module of the foldable electronic device according to the present disclosure in the unfolded state.

FIG. 9 is a top view of the first transmission member, the second transmission member and the elastic module of the foldable electronic device according to the present disclosure in a half-folded state.

FIG. 10 is a top view of the first transmission member, the second transmission member and the elastic module of the foldable electronic device according to the present disclosure in a folded state.

FIG. 11 and FIG. 12 are cross-sectional schematic views of the foldable electronic device according to the present disclosure in the unfolded state, taken from different cross-sections.

FIG. 13 is a cross-sectional schematic view of the foldable electronic device according to the present disclosure in the half-folded state.

FIG. 14 and FIG. 15 are cross-sectional schematic views of the foldable electronic device according to the present disclosure in the folded state, taken from different cross-sections.

### DETAILED DESCRIPTION

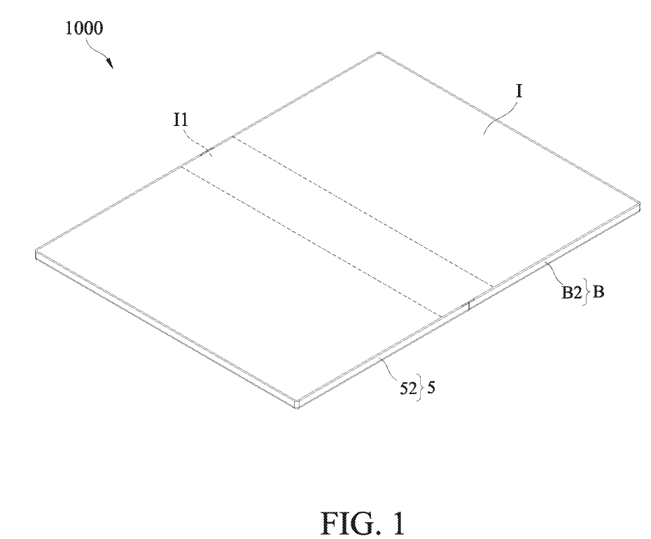

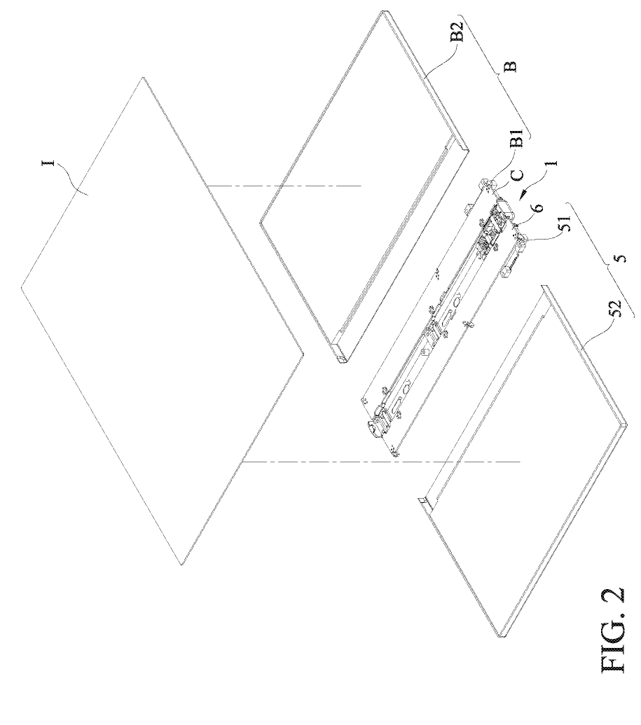

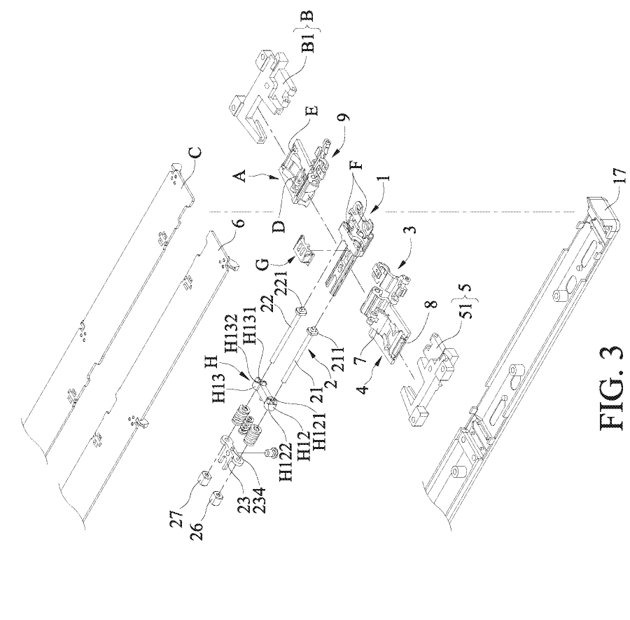

Please refer to FIG. 1, FIG. 2 and FIG. 3, a foldable electronic device 1000 of the present disclosure comprises a central base 1, a pivot module 2, a first wing member 3, a first transmission member 4, a first panel body 5, a first drop plate 6, a first connecting member 7, a first elastic member 8, a second wing member 9, a second transmission member A, a second panel body B, a second drop plate C, a second connecting member D, a second elastic member E, two pushing blocks F, a synchronization module G, an elastic module H and a flexible screen I, wherein the pivot module 2 is disposed on the central base 1, the first wing member 3 and the second wing member 9 are respectively pivotally connected to two sides of the central base 1, the first transmission member 4 and the second transmission member A are respectively connected to the pivot module 2 and two sides of the synchronization module G and the elastic module H, the first panel body 5 is connected to the first wing member 3, the first drop plate 6 is connected to the first panel body 5, the first connecting member 7 is connected to the first transmission member 4 and the first drop plate 6, the first elastic member 8 is disposed on the first transmission member 4, the second panel body B is connected to the second wing member 9, the second drop plate C is connected to the second panel body B, the second connecting member D is connected to the second transmission member A and the second drop plate C, the second elastic member E is disposed on the second transmission member A, the pushing blocks F are spaced apart from each other and disposed on the central base 1, the synchronization module G is disposed on the central base 1 and is able to slide between the first transmission member 4 and the second transmission member A, the elastic module H is disposed on the central base 1 and connected to the pivot module 2, and the flexible screen I is disposed on the central base 1, the first panel body 5, the first drop plate 6, the second panel body B and the second drop plate C. The following describes in detail the structure of each component and their interconnections. Some figures illustrate a first inner virtual axis V1, a second inner virtual axis V2, a first outer virtual axis V3, a second outer virtual axis V4, a first axis X1 and a second axis X2, which are parallel to each other. Certain components of the foldable electronic device 1000 of the present disclosure may be provided as a single set or a plurality of sets, all capable of achieving similar operational effects. For simplification, the following description is provided with using only one set as an example, and some figures also illustrate only one set.

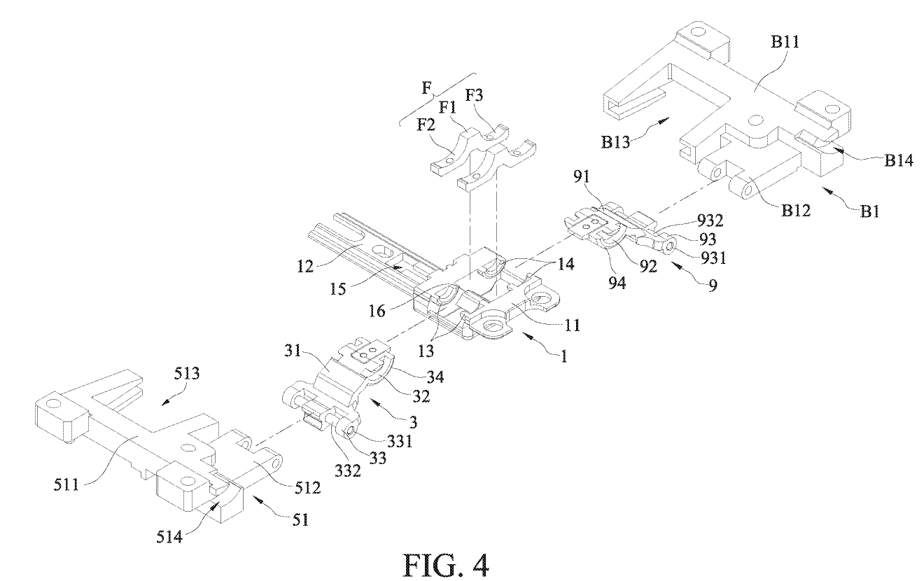

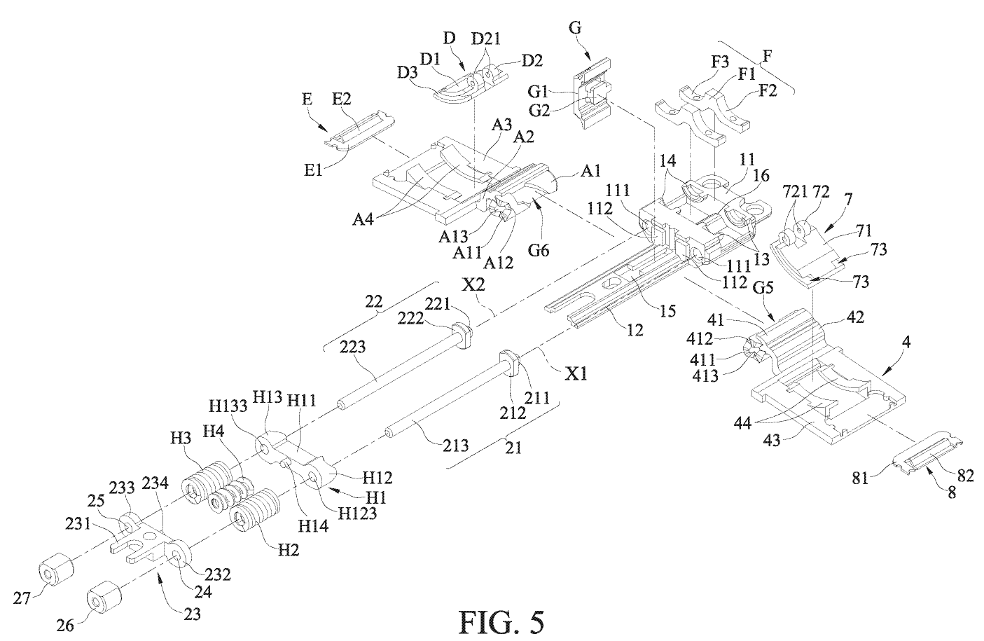

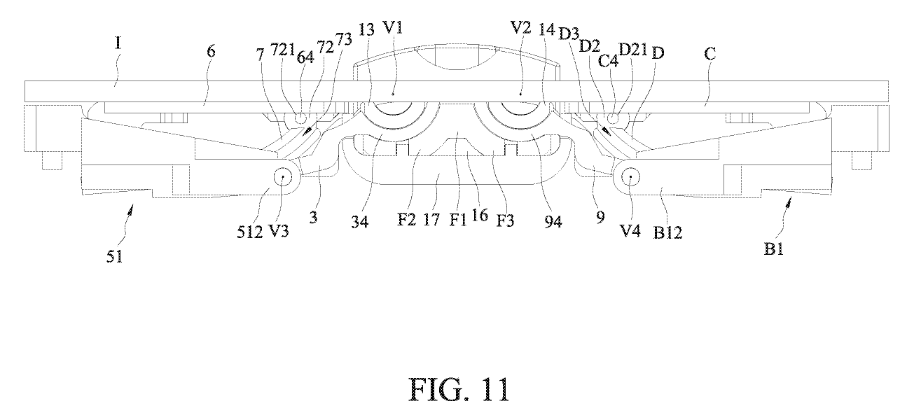

Please refer to FIG. 4 and FIG. 5, the central base 1 includes a body portion 11, a track portion 12, two first inner arc-shaped sliders 13, two second inner arc-shaped sliders 14, a track groove 15, an engaging block 16 and a housing 17. The body portion 11 has two spaced concave holes 111 and two spaced limiting blocks 112, the concave holes 111 are respectively formed along the first axis X1 and the second axis X2, and the limiting blocks 112 are roughly in a shape of a square plate and are respectively adjacent to the concave holes 111. The track portion 12 is roughly in a shape of a long plate and extends outward from the body portion 11. The first inner arc-shaped sliders 13 are roughly in a shape of semi-arc-shaped body, are opposite to each other, are spaced apart from each other, are protruding from the body portion 11, and are adjacent to one side of the body portion 11 (i.e., are adjacent to the first panel body 5), and its common axis is defined as the first inner virtual axis V1 (see FIG. 11). The second inner arc-shaped sliders 14 are roughly in a shape of semi-arc-shaped body, are opposite to each other, are spaced apart from each other, are protruding from the body portion 11, are spaced apart from the first inner arc-shaped sliders 13, and are adjacent to the other side of the body portion 11 (i.e., are adjacent to the second panel body B), and its common axis is defined as the second inner virtual axis V2 (see FIG. 11). The track groove 15 is formed through the track portion 12, and extends parallel to the first axis X1 or the second axis X2. The engaging block 16 is fixedly connected to the body portion 11, is located between the first inner arc-shaped sliders 13 and the second inner arc-shaped sliders 14, and is spaced apart from the first inner arc-shaped sliders 13 and the second inner arc-shaped sliders 14. The housing 17 covers a bottom side and a front side of the body portion 11.

The pivot module 2 includes a first shaft 21, a second shaft 22, a fixed base 23, a first shaft hole 24, a second shaft hole 25, a first nut 26 and a second nut 27. The first shaft 21 extends along the first axis X1 and has a first head portion 211, a first limiting portion 212 and a first rod portion 213 that are sequentially connected. The first head portion 211 is pivotally connected to one of the concave holes 111, the first limiting portion 212 abuts against and is limited by one of the limiting blocks 112, so that the first shaft 21 is not able to self-rotate along the first axis X1. The second shaft 22 extends along the second axis X2 and has a second head portion 221, a second limiting portion 222 and a second rod portion 223 that are sequentially connected. The second head portion 221 is pivotally connected to the other one of the concave holes 111, the second limiting portion 222 abuts against and is limited by the other one of the limiting blocks 112, so that the second shaft 22 is not able to self-rotate along the second axis X2. The fixed base 23 has a base body 231, a first wing portion 232, a second wing portion 233 and a positioning tenon 234. The base body 231 is disposed on the track portion 12, is exposed from the track groove 15, and is spaced apart from the body portion 11. The first wing portion 232 and the second wing portion 233 respectively extend outward from opposite sides of the base body 231. The positioning tenon 234 is disposed on the base body 231 and is located between the first wing portion 232 and the second wing portion 233. The first shaft hole 24 is formed through the first wing portion 232 along the first axis X1, being used for the first rod portion 213 to pass through and pivotally connect to. The second shaft hole 25 is formed through the second wing portion 233 along the second axis X2, being used for the second rod portion 223 to pass through and pivotally connect to. The first nut 26 is screwed at one end of the first rod portion 213 that is away from the first limiting portion 212, and the second nut 27 is screwed at one end of the second rod portion 223 that is away from the second limiting portion 222.

The first wing member 3 includes a first wing body 31, two first inner arc-shaped slideways 32, a first pivot joint portion 33 and two first inner arc-shaped protrusions 34. The first wing body 31 is a bending cuboid. The first inner arc-shaped protrusions 34 extend outward from two sides of the first wing body 31 and are adjacent to the body portion 11. The first inner arc-shaped slideways 32 are respectively surrounded and defined by the first wing body 31 and the first inner arc-shaped protrusions 34, and are respectively used for the first inner arc-shaped sliders 13 to correspondingly and slidably dispose on, whereby the first wing member 3 is able to pivotally rotate relative to the body portion 11 about the first inner virtual axis V1 as a center. The first pivot joint portion 33 is disposed on one side of the first wing body 31 that is away from the body portion 11, and has a first pivot joint hole 331 formed through along the first outer virtual axis V3 and a first pivot joint rod 332 passing through the first pivot joint hole 331.

The first transmission member 4 includes a first driving cam 41, a first bending plate 42, a first straight slider 43 and two first middle arc-shaped sliders 44. The first driving cam 41 is an end cam and has three first main convex portions 411, three first main concave portions 412 and a first main penetration hole 413. The first main convex portions 411 and the first main concave portions 412 extend outward along the first axis X1 and are interlaced with one another in an annular configuration, and the first main penetration hole 413 is formed through along the first axis X1 and is used for the first rod portion 213 to pass through. The first bending plate 42 extends outward from the first driving cam 41 along a radial direction of the first axis X1. The first straight slider 43 extends outward from the first bending plate 42 along the radial direction of the first axis X1. The first middle arc-shaped sliders 44 are spaced apart from each other and formed on the first straight slider 43.

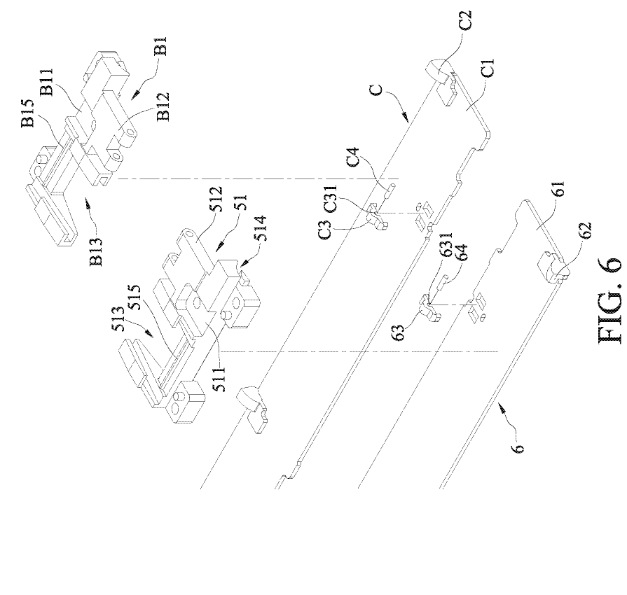

Please refer to FIG. 6, the first panel body 5 includes a first carrying member 51 and a first panel housing 52. The first carrying member 51 has a first carrying body 511, a first pivoting portion 512, a first straight slide groove 513, a first outer arc-shaped slideway 514 and a first convex rib 515. The first pivoting portion 512 extends outward from the first carrying body 511 and is pivotally connected to the first pivot joint rod 332, thereby jointly defining the first outer virtual axis V3 (see FIG. 11), so that the first carrying member 51 is able to rotate relative to the first wing member 3 about the first outer virtual axis V3. The first straight slide groove 513 is surrounded and defined by the first carrying body 511, is roughly perpendicular to the first axis X1, and is used for the first straight slider 43 to linearly and slidably dispose on, whereby the first carrying member 51 is able to linearly move relative to the first transmission member 4. The first outer arc-shaped slideway 514 is formed on the first carrying body 511 and is spaced apart from the first pivoting portion 512. The first convex rib 515 extends parallel to the first axis X1, is formed on the first carrying body 511, and is adjacent to the first straight slide groove 513. The first panel housing 52 is roughly in a shape of a cuboid and is fixedly connected to the first carrying member 51. In addition, the first panel body 5 further includes electronic components, which are not directly related to the folding operation and therefore are not described in detail herein.

The first drop plate 6 includes a first plate body 61, a first outer arc-shaped slider 62, a first fixed member 63 and a first insert rod 64. The first plate body 61 is roughly in a shape of a cuboid, and the first outer arc-shaped slider 62 is disposed at one corner of the first plate body 61 and is slidably disposed on the first outer arc-shaped slideway 514, so that the first drop plate 6 is able to be pivotally carried on the first carrying member 51. The first fixed member 63 is fixedly disposed on a bottom surface of the first plate body 61 and has a first perforation hole 631. The first insert rod 64 passes through the first perforation hole 631, and opposite ends of the first insert rod 64 are exposed from the first fixed member 63.

The first connecting member 7 includes a first connecting body 71, a first pivot portion 72 and two first middle arc-shaped slide grooves 73. The first connecting body 71 is roughly in a shape of an arc-shaped body. The first pivot portion 72 is disposed on one side of the first connecting body 71 and has two first through holes 721, and the first insert rod 64 passes through the first through holes 721 of the first pivot portion 72, so that the

first connecting body 71 is able to pivotally rotate relative to the first drop plate 6. The first middle arc-shaped slide grooves 73 are spaced apart from each other and are recessed on opposite sides of the first connecting body 71, and the first middle arc-shaped sliders 44 are respectively and slidably disposed in the first middle arc-shaped slide grooves 73.

The first elastic member 8 includes a first sheet body 81 and a first bending body 82. The first sheet body 81 is roughly U-shaped, and is buckled at one end of the first straight slider 43 that is away from the first bending plate 42. The first bending body 82 roughly has a V-shaped cross-section, and is bent outward from the first sheet body 81.

The second wing member 9 includes a second wing body 91, two second inner arc-shaped slideways 92, a second pivot joint portion 93 and two second inner arc-shaped protrusions 94. The second wing body 91 is a bending cuboid. The second inner arc-shaped protrusions 94 extend outward from two sides of the second wing body 91 and are adjacent to the body portion 11. The second inner arc-shaped slideways 92 are respectively surrounded and defined by the second wing body 91 and the second inner arc-shaped protrusions 94, and are respectively used for the second inner arc-shaped sliders 14 to correspondingly and slidably dispose on, whereby the second wing member 9 is able to pivotally rotate relative to the body portion 11 about the second inner virtual axis V2 as a center. The second pivot joint portion 93 is disposed on one side of the second wing body 91 that is away from the body portion 11, and has a second pivot joint hole 931 formed through along the second outer virtual axis V4 and a second pivot joint rod 932 passing through the second pivot joint hole 931.

The second transmission member A includes a second driving cam A1, a second bending plate A2, a second straight slider A3 and two second middle arc-shaped sliders A4. The second driving cam A1 is an end cam and has three second main convex portions A11, three second main concave portions A12 and a second main penetration hole A13. The second main convex portions A11 and the second main concave portions A12 extend outward along the second axis X2 and are interlaced with one another in an annular configuration, and the second main penetration hole A13 is formed through along the second axis X2 and is used for the second rod portion 223 to pass through. The second bending plate A2 extends outward from the second driving cam A1 along a radial direction of the second axis X2. The second straight slider A3 extends outward from the second bending plate A2 along the radial direction of the second axis X2. The second middle arc-shaped sliders A4 are spaced apart from each other and are formed on the second straight slider A3.

The second panel body B includes a second carrying member B1 and a second panel housing B2. The second carrying member B1 has a second carrying body B11, a second pivoting portion B12, a second straight slide groove B13, a second outer arc-shaped slideway B14 and a second convex rib B15. The second pivoting portion B12 extends outward from the second carrying body B11 and is pivotally connected to the second pivot joint rod 932, thereby jointly defining the second outer virtual axis V4 (see FIG. 11), so that the second carrying member B1 is able to rotate relative to the second wing member 9 about the second outer virtual axis V4. The second straight slide groove B13 is surrounded and defined by the second carrying body B11, is roughly perpendicular to the second axis X2, and is used for the second straight slider A3 to linearly and slidably dispose on, whereby the second carrying member B1 is able to linearly move relative to the second transmission member A. The second outer arc-shaped slideway B14 is formed on the second carrying body B11 and is spaced apart from the second pivoting portion B12. The second convex rib B15 is parallel to the second axis X2, is formed on the second carrying body B11, and is adjacent to the second straight slide groove B13. The second panel housing B2 is roughly in a shape of a cuboid, is fixedly connected to the second carrying member B1, and is co-planar with the first carrying member 51. In addition, the second panel body B further includes electronic components, which are likewise not described in detail herein.

The second drop plate C includes a second plate body C1, a second outer arc-shaped slider C2, a second fixed member C3 and a second insert rod C4. The second plate body C1 is roughly in a shape of a cuboid, and the second outer arc-shaped slider C2 is disposed at one corner of the second plate body C1, and is slidably disposed on the second outer arc-shaped slideway B14, so that the second drop plate C is able to be pivotally carried on the second carrying member B1. The second fixed member C3 is fixedly disposed on a bottom surface of the second plate body C1 and has a second perforation hole C31. The second insert rod C4 passes through the second perforation hole C31, and opposite ends of the second insert rod C4 are exposed from the second fixed member C3.

The second connecting member D includes a second connecting body D1, a second pivot portion D2 and two second middle arc-shaped slide grooves D3. The second connecting body D1 is roughly in a shape of an arc-shaped body. The second pivot portion D2 is disposed on one side of the second connecting body D1 and has two second through holes D21, and the second insert rod C4 passes through the second through holes D21 of the second pivot portion D2, so that the second connecting body D1 is able to pivotally rotate relative to the second drop plate C. The second middle arc-shaped slide grooves D3 are spaced apart from each other and are recessed and formed on opposite sides of the second connecting body D1, and the second middle arc-shaped sliders A4 are respectively and slidably disposed in the second middle arc-shaped slide grooves D3.

The second elastic member E includes a second sheet body E1 and a second bending body E2. The second sheet body E1 is roughly U-shaped, and is buckled at one end of the second straight slider A3 that is away from the second bending plate A2. The second bending body E2 roughly has a V-shaped cross-section, is formed outward from the second sheet body E1, and is bent.

The pushing blocks F are spaced apart from each other and are disposed on the body portion 11, and respectively have a main portion F1, a first extending portion F2 and a second extending portion F3. The main portion F1 is located between the first wing member 3 and the second wing member 9. The first extending portion F2 and the second extending portion F3 respectively bend outward from two sides of the main portion F1. The first extending portion F2 is sandwiched between the body portion 11 and the first inner arc-shaped protrusions 34, abuts against and pushes the first inner arc-shaped protrusions 34, so that the first inner arc-shaped protrusions 34 approach the first inner arc-shaped sliders 13, a gap between the first inner arc-shaped protrusions 34 and the first inner arc-shaped sliders 13 is decreased, and a sliding space between the first inner arc-shaped sliders 13 and the first extending portions F2 is formed and is used for the first inner arc-shaped protrusions 34 to slidably dispose on. The second extending portion F3 is sandwiched between the body portion 11 and the second inner arc-shaped protrusions 94, abuts against and pushes the second inner arc-shaped protrusions 94, so that the second inner arc-shaped protrusions 94 approach the second inner arc-shaped sliders 14, a gap between the second inner arc-shaped protrusions 94 and the second inner arc-shaped sliders 14 is decreased, and a sliding space between the second inner arc-shaped sliders 14 and the second extending portions F3 is formed and is used for the second inner arc-shaped protrusions 94 to slidably dispose on. External shapes of the main portion F1, the first extending portion F2 and the second extending portion F3 collectively match an external shape of the engaging block 16, so that the pushing blocks F are engaged with the engaging block 16. In an embodiment, the pushing blocks F are made of an elastic material such as plastic.

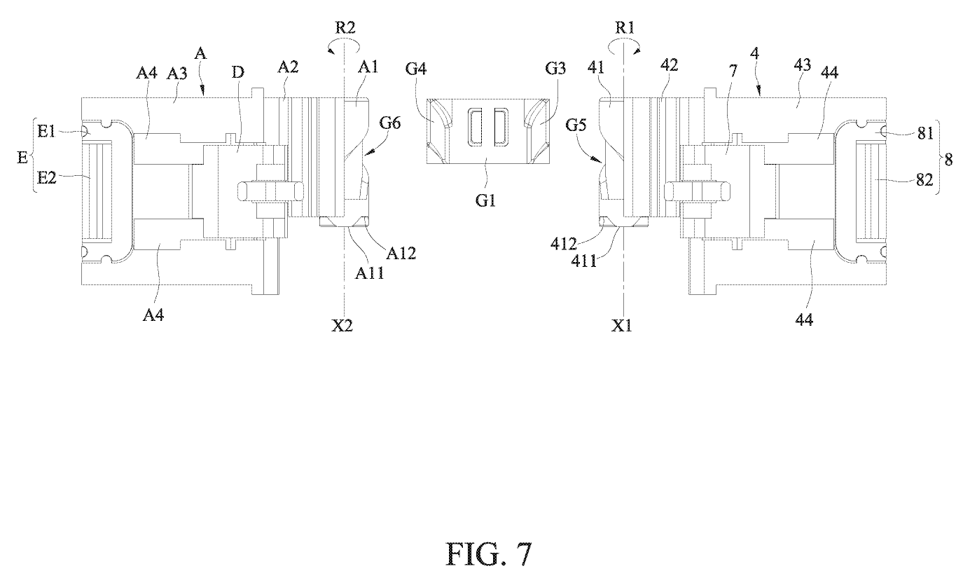

Please also refer to FIG. 7, the synchronization module G includes a synchronization slider body G1, a limiting rib G2, a first helical protrusion G3, a second helical protrusion G4, a first helical groove G5 and a second helical groove G6. The synchronization slider body G1 is able to be slidably disposed between the first transmission member 4 and the second transmission member A and on the track portion 12 and is connected to the first transmission member 4 and the second transmission member A. The limiting rib G2 extends outward from a bottom surface of the synchronization slider body G1 and is able to be slidably accommodated in the track groove 15, whereby the synchronization slider body G1 is able to move along the track groove 15. The first helical protrusion G3 is formed on one of opposite side surfaces of the synchronization slider body G1 along a first helical direction R1. The second helical protrusion G4 is formed on the other one of opposite side surfaces of the synchronization slider body G1 along a second helical direction R2. The first helical groove G5 is recessed and formed on the first driving cam 41 along the first helical direction R1, and is matched with and accommodates the first helical protrusion G3. The second helical groove G6 is recessed and formed on the second driving cam A1 along the second helical direction R2, and is matched with and accommodates the second helical protrusion G4. In an embodiment, the first helical direction R1 and the second helical direction R2 are opposite to each other, but are not limited to as such. In another embodiment, the first helical groove G5 and the second helical groove G6 are also able to be recessed and formed on the opposite side surfaces of the synchronization slider body G1 respectively, and the first helical protrusion G3 and the second helical protrusion G4 are also able to be respectively formed on the first driving cam 41 and the second driving cam A1.

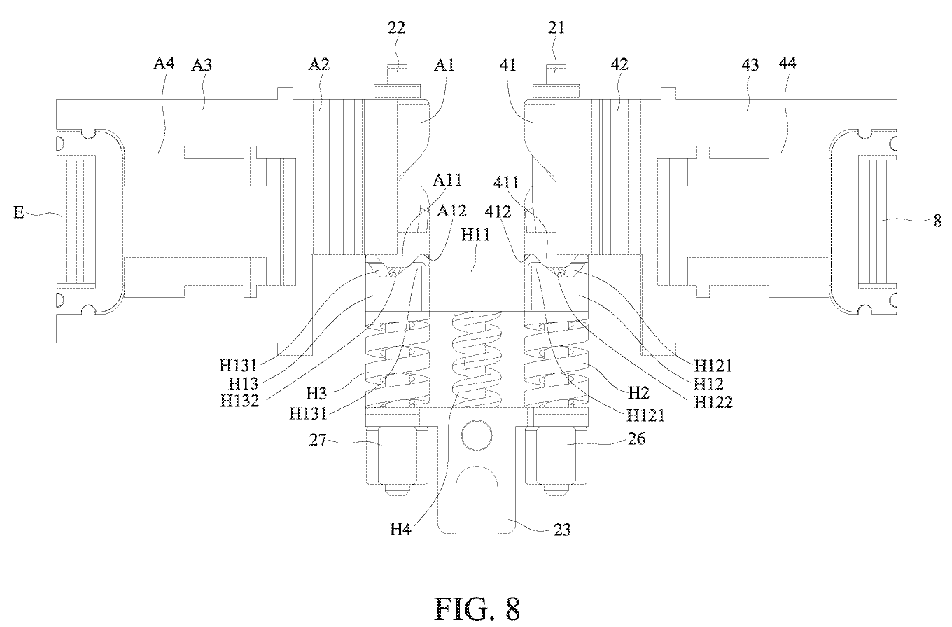

The elastic module H includes a pushing member H1, a first elastic member H2, a second elastic member H3 and a third elastic member H4. The pushing member H1 is able to be slidably sleeved on the first rod portion 213 and the second rod portion 223, and has a pushing body H11, a first driven cam H12, a second driven cam H13 and a positioning column H14. The pushing body H11 is roughly in a shape of a cuboid. The first driven cam H12 is an end cam, extends outward from one side of the pushing body H11, is able to be matched and engaged with the first driving cam 41 movably (see FIG. 8 to FIG. 10), and has three first slave convex portions H121, three first slave concave portions H122 and a first slave penetration hole H123. The first slave convex portions H121 are spaced apart from each other and extend outward along the first axis X1, and the first slave concave portions H122 are spaced apart from each other and are formed between any two of the first slave convex portions H121. The first slave penetration hole H123 is formed through along the first axis X1 and is used for the first rod portion 213 to pass through, and a cross-sectional area of the first slave penetration hole H123 is greater than a cross-sectional area of the first rod portion 213 and is in a round shape, whereby the first driven cam H12 is able to slide on the first rod portion 213 along the first axis X1, but is not rotated synchronously with the first rod portion 213. The second driven cam H13 is an end cam, extends outward from the other side of the pushing body H11, is able to be matched and engaged with the second driving cam A1 movably (see FIG. 8 to FIG. 10), and has three second slave convex portions H131, three second slave concave portions H132 and a second slave penetration hole H133. The second slave convex portions H131 are spaced apart from each other and extend outward along the second axis X2, and the second slave concave portions H132 are spaced apart from each other and are formed between any two of the second slave convex portions H131. The second slave penetration hole H133 is formed through along the second axis X2 and is used for the second rod portion 223 to pass through, and a cross-sectional area of the second slave penetration hole H133 is greater than a cross-sectional area of the second rod portion 223 and is in a round shape, whereby the second driven cam H13 is able to slide on the second rod portion 223 along the second axis X2, but is not rotated synchronously with the second rod portion 223. The positioning column H14 extends outward from a back side of the pushing body H11 along a direction parallel to the first axis X1 or the second axis X2. The first elastic member H2 is sleeved on the first rod portion 213, and opposite ends of the first elastic member H2 respectively abut against the first wing portion 232 and the first driven cam H12. The second elastic member H3 is sleeved on the second rod portion 223, and opposite ends of the second elastic member H3 respectively abut against the second wing portion 233 and the second driven cam H13. The third elastic member H4 is sleeved on the positioning tenon 234 and the positioning column H14 and is located between the first elastic member H2 and the second elastic member H3, and opposite ends of the third elastic member H4 respectively abut against the fixed base 23 and the pushing member H1. In an embodiment, the first elastic member H2, the second elastic member H3 and the third elastic member H4 are respectively compression springs.

The flexible screen I is disposed on the first panel body 5, the first drop plate 6, the second panel body B, the second drop plate C and the central base 1, and includes a bendable region I1, and the bendable region I1 roughly corresponds to the central base 1, the first wing member 3, the first drop plate 6, the second wing member 9 and the second drop plate C.

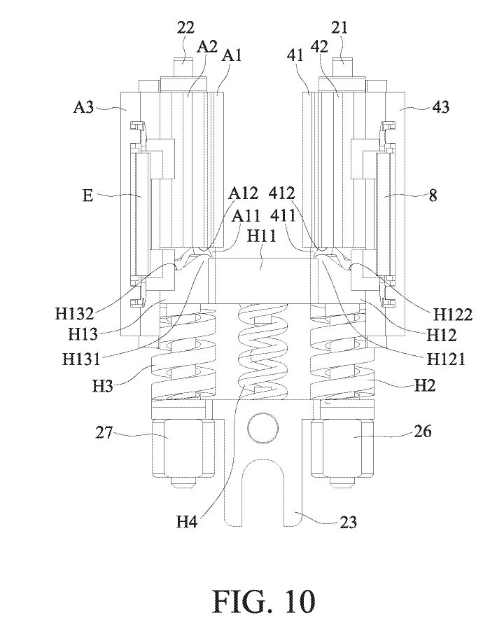

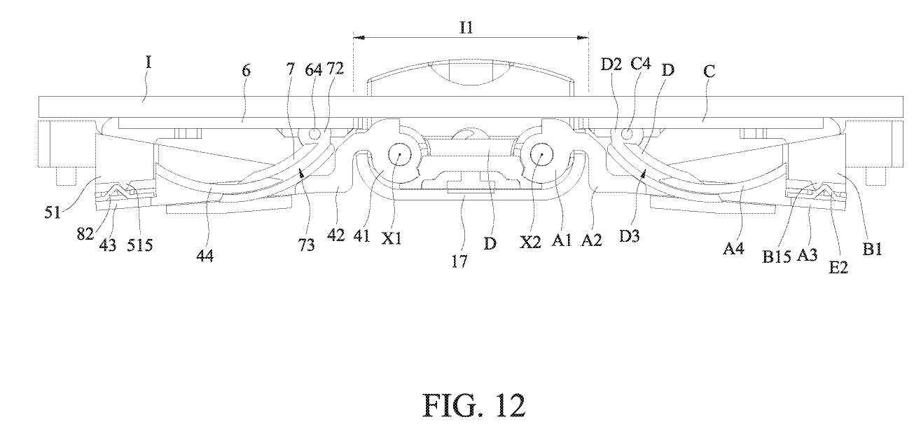

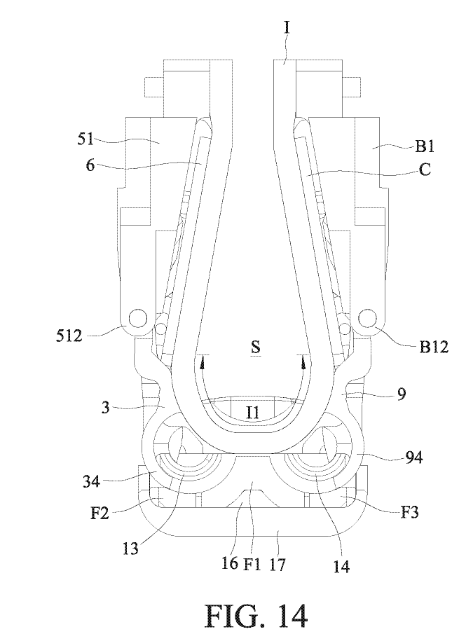

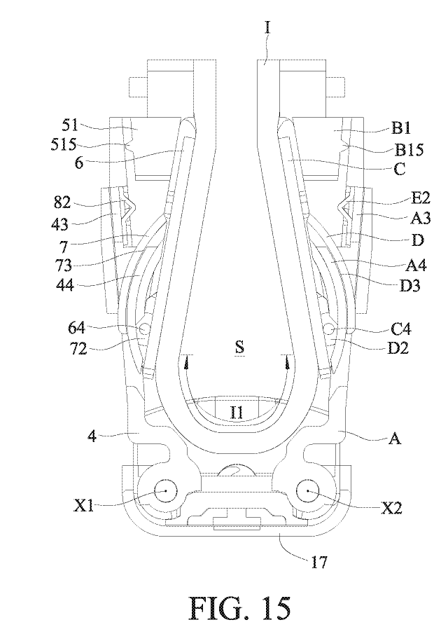

The following describes operations of the foldable electronic device 1000 of the present disclosure. The first panel body 5 and the second panel body B are able to transform between an unfolded state (see FIG. 8, FIG. 11 and FIG. 12) and a folded state (see FIG. 10, FIG. 14 and FIG. 15). In the unfolded state, the flexible screen I is flattened, the first drop plate 6, the second drop plate C and the central base 1 jointly support the bendable region I1, and the first drop plate 6 and the second drop plate C contact a top side of the housing 17. As shown in FIG. 8 (only the pivot module 2, the first transmission member 4, the second transmission member A and the elastic module H are shown), at this time, the first driving cam 41 and the first driven cam H12 are matched with and are engaged each other. That is, each of the first main convex portions 411 respectively extends into each of the first slave concave portions H122 and respectively and correspondingly generates friction between each of partial sides, a sum of a length of the first driving cam 41 and a length of the first driven cam H12 on the first axis X1 is the smallest, the second driving cam A1 and the second driven cam H13 are matched and engaged with each other, that is, each of the second main convex portions A11 respectively extends into each of the second slave concave portions H132 and respectively and correspondingly generates friction between each of partial sides, a sum of a length of the second driving cam A1 and a length of the second driven cam H13 on the second axis X2 is the smallest, and the first elastic member H2, the second elastic member H3 and the third elastic member H4 are correspondingly released (i.e., the compression amount is the smallest). At this time, as shown in FIG. 11, the first extending portions F2 abut against and push all of the first inner arc-shaped protrusions 34, so that the first inner arc-shaped protrusions 34 approach or cling to the first inner arc-shaped sliders 13, and the second extending portions F3 abut against and push all of the second inner arc-shaped protrusions 94, so that the second inner arc-shaped protrusions 94 approach or cling to the second inner arc-shaped sliders 14. At this time, as shown in FIG. 12, a small portion of the first middle arc-shaped sliders 44 is located in the first middle arc-shaped slide grooves 73, a small portion of the second middle arc-shaped sliders A4 is located in the second middle arc-shaped slide grooves D3, the first bending body 82 of the first elastic member 8 abuts against a left side of the first convex rib 515, and the second bending body E2 of the second elastic member E abuts against a right side of the second convex rib B15.

When the first panel body 5 and the second panel body B transform from the unfolded state to the folded state, the first wing member 3 and the second wing member 9 respectively pivotally rotate relative to the body portion 11 about the first inner virtual axis V1 and the second inner virtual axis V2 as the centers and gradually approach each other (i.e., the first drop plate 6 and the second drop plate C gradually transform from a state of being coplanar to a state of being obliquely interlaced with each other). Simultaneously, the first carrying member 51 and the second carrying member B1 also respectively pivotally move relative to the first wing member 3 and the second wing member 9 about the first outer virtual axis V3 and the second outer virtual axis V4 as the centers, the first straight slider 43 and the second straight slider A3 respectively linearly slide in the first straight slide groove 513 and the second straight slide groove B13 (i.e., gradually sliding away from the first straight slide groove 513 and the second straight slide groove B13), simultaneously, the first driving cam 41 and the first bending plate 42 pivotally rotate about the first axis X1 as a center, and the second driving cam A1 and the second bending plate A2 pivotally rotate about the second axis X2 as a center. Since the first helical direction R1 of the first helical groove G5 and the second helical direction R2 of the second helical groove G6 on two side surfaces of the synchronization slider body G1 are opposite to each other, the first helical protrusion G3 and the second helical protrusion G4 respectively slide along the first helical groove G5 and the second helical groove G6, thereby driving the first transmission member 4 and the second transmission member A to rotate synchronously and reversely. Simultaneously, the first connecting member 7 pivotally rotates relative to the first drop plate 6 about the first insert rod 64 as an axis, the first middle arc-shaped sliders 44 slide in the first middle arc-shaped slide grooves 73, the first bending body 82 is pushed by the first convex rib 515 and compressed toward the first straight slider 43, the second connecting member D pivotally rotates relative to the second drop plate C about the second insert rod C4 as an axis, the second middle arc-shaped sliders A4 slide in the second middle arc-shaped slide grooves D3, and the second bending body E2 is pushed by the second convex rib B15 and compressed toward the second straight slider A3.

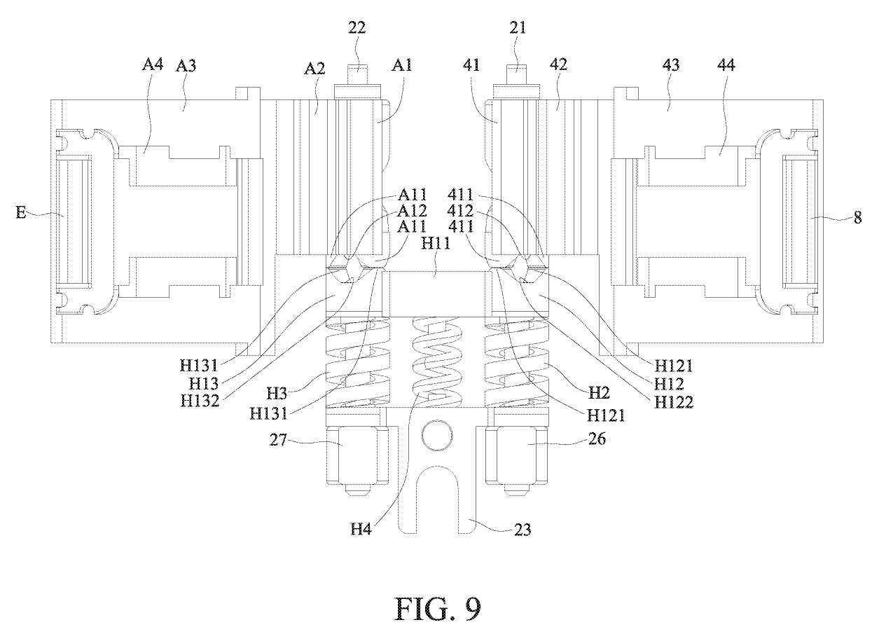

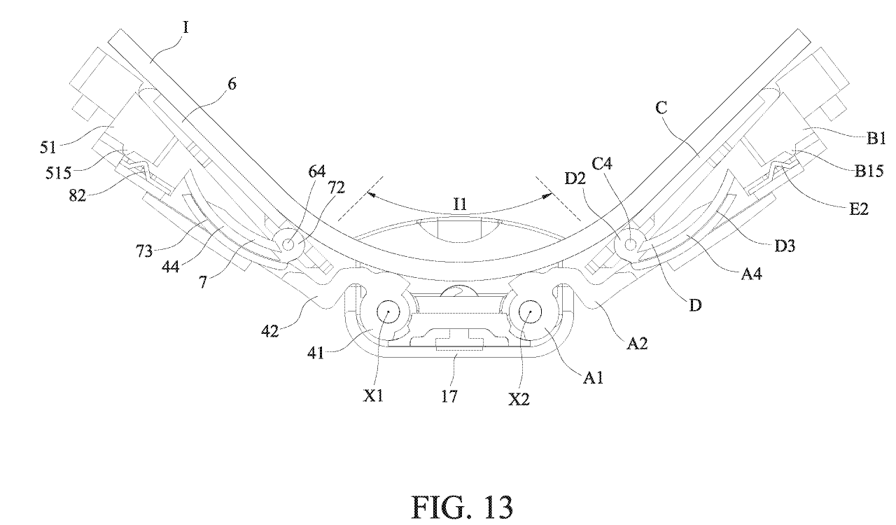

In the aforementioned process of transforming, the first driving cam 41 and the second driving cam A1 gradually push away the first driven cam H12 and the second driven cam H13, gradually compress the first elastic member H2, the second elastic member H3 and the third elastic member H4 (i.e., the compression amount gradually increases). When the first panel body 5 and the second panel body B transform to the half-folded state between the unfolded state and the folded state, as shown in FIG. 9, the first driving cam 41 and the second driving cam A1 respectively and mutually abut against the first driven cam H12 and the second driven cam H13, that is, each of the first main convex portions 411 respectively and correspondingly abuts against each of the first slave convex portions H121, each of the first main concave portions 412 respectively corresponds to each of the first slave concave portions H122, each of the second main convex portions A11 respectively and correspondingly abuts against each of the second slave convex portions H131, each of the second main concave portions A12 respectively corresponds to each of the second slave concave portions H132, the pushing member H1 moves toward the fixed base 23 along the first shaft 21 and the second shaft 22, whereby compressing the first elastic member H2, the second elastic member H3 and the third elastic member H4 (i.e., the compression amount is the greatest), at this time, a sum of a length of the first driving cam 41 and a length of the first driven cam H12 on the first axis X1 is greatest, and a sum of a length of the second driving cam A1 and a length of the second driven cam H13 on the second axis X2 is the greatest. Simultaneously, as shown in FIG. 13, a portion of the first middle arc-shaped sliders 44 located in the first middle arc-shaped slide grooves 73 increases, one end of the first drop plate 6 changes from being adjacent to the first driving cam 41 (see FIG. 12) to being adjacent to the first bending plate 42 (see FIG. 13), roughly being obliquely interlaced with the first carrying member 51 (i.e., the first drop plate 6 is forced to self-spin by an angle), a portion of the second middle arc-shaped sliders A4 located in the second middle arc-shaped slide grooves D3 increases, and one end of the second drop plate C changes from being adjacent to the second driving cam A1 (see FIG. 12) to being adjacent to the second bending plate A2 (see FIG. 13), roughly being obliquely interlaced with the second carrying member B1 (i.e., the second drop plate C is forced to self-spin by an angle). The compressed first bending body 82 rebounds after passing through the first convex rib 515 and then is gradually away from a right side of the first convex rib 515. The compressed second bending body E2 rebounds after passing through the second convex rib B15, and then is gradually away from a left side of the second convex rib B15.

When continuously transforming the first panel body 5 and the second panel body B to the folded state, as shown in FIG. 10, the first driving cam 41 and the first driven cam H12 are gradually matched and engaged with each other, that is, each of the first main convex portions 411 respectively and gradually extends into each of the first slave concave portions H122 again, a side surface of each of the first main convex portions 411 respectively and partially contacts a side surface of each of the first slave convex portions H121 (mutually contacts the other side) and generates friction, the second driving cam A1 and the second driven cam H13 are also gradually matched and engaged with each other, that is, each of the second main convex portions A11 respectively and gradually extends into each of the second slave concave portions H132, a side surface of each of the second main convex portions A11 respectively and partially contacts a side surface of each of the second slave convex portions H131 (mutually contacts the other side) and generates friction, and causing the first elastic member H2, the second elastic member H3 and the third elastic member H4 being gradually released (i.e., the compression amount gradually decreases). Simultaneously, as shown in FIG. 14, a portion of the first extending portions F2 still abuts against and pushes an end of the first inner arc-shaped protrusions 34, so that the first inner arc-shaped sliders 13 do not separate from the first inner arc-shaped slideways 32 (

that is, the first inner arc-shaped protrusions 34 are still slidably disposed in the sliding space between the first inner arc-shaped sliders 13 and the first extending portions F2), a portion of the second extending portions F3 still abuts against and pushes all of an end of the second inner arc-shaped protrusions 94, so that the second inner arc-shaped sliders 14 do not separate from the second inner arc-shaped slideways 92 (that is, the second inner arc-shaped protrusions 94 are still slidably disposed in the sliding space between the second inner arc-shaped sliders 14 and the second extending portions F3). Simultaneously, as shown in FIG. 15, most of the first middle arc-shaped sliders 44 are located in the first middle arc-shaped slide grooves 73, most of the second middle arc- shaped sliders A4 are located in the second middle arc-shaped slide grooves D3, the first bending body 82 is further away from the other side of the first convex rib 515, and the second bending body E2 is further away from the other side of the second convex rib B15.

When transforming to the folded state, a sum of a length of the first driving cam 41 and a length of the first driven cam H12 on the first axis X1 is the smallest, a sum of a length of the second driving cam A1 and a length of the second driven cam H13 on the second axis X2 is the smallest, the first elastic member H2, the second elastic member H3 and the third elastic member H4 are released, the first drop plate 6 and the second drop plate C are away from the top side of the housing 17, the first drop plate 6 and the second drop plate C are respectively obliquely interlaced with the body portion 11, the bendable region I1 of the flexible screen I is bent, the first drop plate 6, the second drop plate C and the central base 1 jointly define an accommodation space S to accommodate the bendable region I1, and the bendable region I1, the first drop plate 6 and the second drop plate C are integrally and roughly in a shape of a water drop.

To sum up, in the foldable electronic device of the present disclosure, via the pushing blocks abutting against the first wing member and the second wing member, a gap between a lower edge of the first inner arc-shaped sliders and an upper edge of the first inner arc-shaped protrusions is reduced and a gap between a lower edge of the second inner arc-shaped sliders and an upper edge of the second inner arc-shaped protrusions is reduced, so that when the first wing member and the second wing member are transformed to the folded state, the first inner arc-shaped sliders do not separate from the first inner arc-shaped slideways, the first inner arc-shaped protrusions do not separate from a sliding space between the first inner arc-shaped sliders and the first extending portions, the second inner arc-shaped sliders do not separate from the second inner arc-shaped slideways, and the second inner arc-shaped protrusions do not separate from a sliding space between the second inner arc-shaped sliders and the second extending portions, whereby a user can experience smooth and jam-free operation during repeated folding. Additionally, the coordinated arrangement of the first elastic member, the first convex rib, the second elastic member and the second convex rib provides the user with a tactile “snap-over” feeling during folding.

What is claimed is:

1. A foldable electronic device, comprising:
a central base including a body portion, a track portion, at least one first inner arc-shaped slider and at least one second inner arc-shaped slider, wherein the track portion is formed by extending outward from the body portion, and the first inner arc-shaped slider and the second inner arc-shaped slider are spaced apart from each other and are formed on the body portion;
a pivot module disposed on the central base and including a first shaft and a second shaft respectively and pivotally connected to the body portion;
a first wing member including at least one first inner arc-shaped slideway and a first pivot joint portion, wherein the first inner arc-shaped slider is slidably disposed on the first inner arc-shaped slideway, whereby the first wing member is able to pivotally rotate relative to the body portion about a first inner virtual axis as a center;
a first transmission member sleeved on the first shaft and including at least one first middle arc-shaped slider;
a first panel body including a first carrying member, wherein the first carrying member has a first pivoting portion and a first straight slide groove, and the first pivoting portion is pivotally connected to the first pivot joint portion and jointly defines a first outer virtual axis, whereby the first carrying member is able to rotate relative to the first wing member about the first outer virtual axis, and the first transmission member is slidably disposed in the first straight slide groove, whereby the first carrying member is able to linearly slide relative to the first transmission member;
a first drop plate pivotally carried on the first carrying member;
a first connecting member pivotally connected to the first drop plate and including at least one first middle arc-shaped slide groove, wherein the first middle arc-shaped slider is slidably disposed in the first middle arc-shaped slide groove;
a second wing member including at least one second inner arc-shaped slideway and a second pivot joint portion, wherein the second inner arc-shaped slider is slidably disposed on the second inner arc-shaped slideway, whereby the second wing member is able to pivotally rotate relative to the body portion about a second inner virtual axis as a center;
a second transmission member sleeved on the second shaft and including at least one second middle arc-shaped slider;
a second panel body including a second carrying member, wherein the second carrying member has a second pivoting portion and a second straight slide groove, and the second pivoting portion is pivotally connected to the second pivot joint portion and jointly defines a second outer virtual axis, whereby the second carrying member is able to rotate relative to the second wing member about the second outer virtual axis, and the second transmission member is slidably disposed in the second straight slide groove, whereby the second carrying member is able to linearly slide relative to the second transmission member;
a second drop plate pivotally carried on the second carrying member;
a second connecting member pivotally connected to the second drop plate and including at least one second middle arc-shaped slide groove, wherein the second middle arc-shaped slider is slidably disposed in the second middle arc-shaped slide groove;
at least one pushing block disposed on the body portion, spaced apart from the first inner arc-shaped slider and the second inner arc-shaped slider, and contacting and pushing the first wing member and the second wing member to respectively approach the first inner arc-shaped slider and the second inner arc-shaped slider;
a synchronization module including a synchronization slider body slidably disposed between the first transmission member and the second transmission member, wherein the first transmission member and the second transmission member are respectively connected to the synchronization slider body, and when the synchronization slider body slides, the synchronization slider body is able to respectively drive the first transmission member and the second transmission member to rotate synchronously and reversely;
an elastic module including a pushing member, wherein the pushing member is slidably sleeved on the first shaft and the second shaft and is movably engaged with the first transmission member and the second transmission member; and
a flexible screen disposed on the first panel body, the second panel body, the first drop plate, the second drop plate and the central base, and the flexible screen including a bendable region,
wherein the first panel body and the second panel body are able to transform between an unfolded state and a folded state, wherein when the first panel body and the second panel body are in the unfolded state, the flexible screen is flattened, and the first drop plate, the second drop plate and the central base jointly support the bendable region, and wherein when the first panel body and the second panel body are in the folded state, the bendable region of the flexible screen is bent, the first drop plate, the second drop plate and the central base jointly define an accommodation space to accommodate the bendable region, and the first wing member and the second wing member pushed by the pushing block are not able to separate from the first inner arc-shaped slider and the second inner arc-shaped slider.

2. The foldable electronic device of claim 1, wherein the pushing block includes a main portion, a first extending portion and a second extending portion, and wherein the main portion is disposed between the first wing member and the second wing member, the first extending portion and the second extending portion respectively extend outward from opposite sides of the main portion and are bent, the first extending portion is sandwiched between the first wing member and the central base, and the second extending portion is sandwiched between the second wing member and the central base.

3. The foldable electronic device of claim 2, wherein the first wing member further includes at least one first inner arc-shaped protrusion, and the first inner arc-shaped slideway is surrounded and defined by the first inner arc-shaped protrusion, wherein the second wing member further includes at least one second inner arc-shaped protrusion, and the second inner arc-shaped slideway is surrounded and defined by the second inner arc-shaped protrusion, wherein the first extending portion and the second extending portion respectively abut against and push the first inner arc-shaped protrusion and the second inner arc-shaped protrusion, so that the first wing member and the second wing member respectively approach the first inner arc-shaped slider and the second inner arc-shaped slider, and wherein the pushing block is made of an elastic material.

4. The foldable electronic device of claim 3, wherein the first drop plate includes a first outer arc-shaped slider and a first insert rod, the first carrying member further has a first outer arc-shaped slideway, the first outer arc-shaped slider is slidably disposed on the first outer arc-shaped slideway, the first connecting member further includes a first pivot portion, and the first insert rod passes through the first pivot portion, wherein the second drop plate includes a second outer arc-shaped slider and a second insert rod, the second carrying member further includes a second outer arc-shaped slideway, the second outer arc-shaped slider is slidably disposed on the second outer arc-shaped slideway, the second connecting member further includes a second pivot portion, and the second insert rod passes through the second pivot portion, and wherein the central base further includes an engaging block, external shapes of the main portion, the first extending portion and the second extending portion of the pushing block collectively match an external shape of the engaging block, so that the pushing block is engaged with the engaging block.

5. The foldable electronic device of claim 4, wherein the first shaft extends along a first axis, the first straight slide groove extends substantially perpendicular to the first axis, the first transmission member further includes a first bending plate and a first straight slider, the first bending plate extends along a radial direction of the first axis and is bent, the first straight slider extends outward from the first bending plate along the radial direction of the first axis and is slidably disposed in the first straight slide groove, and the first middle arc-shaped slider is formed on the first straight slider, and wherein the second shaft extends along a second axis, the second straight slide groove extends substantially perpendicular to the second axis, the second transmission member further includes a second bending plate and a second straight slider, the second bending plate extends along a radial direction of the second axis and is bent, the second straight slider extends outward from the second bending plate along the radial direction of the second axis and is slidably disposed in the second straight slide groove, and the second middle arc-shaped slider is formed on the second straight slider.

6. The foldable electronic device of claim 5, further comprising a first elastic member and a second elastic member, wherein the first elastic member is buckled in the first straight slider and is away from the first bending plate, the second elastic member is buckled in the second straight slider and is away from the second bending plate, the first carrying member further has a first convex rib, the second carrying member further has a second convex rib, wherein when the first panel body and the second panel body are in the unfolded state, the first elastic member abuts against the first convex rib, and the second elastic member abuts against the second convex rib, and wherein in a process of transforming the first panel body and the second panel body from the unfolded state to the folded state, the first elastic member is pushed and compressed by the first convex rib, crossing through and gradually moving away from the first convex rib, and the second elastic member is pushed and compressed by the second convex rib, crossing through and gradually moving away from the second convex rib.

7. The foldable electronic device of claim 6, wherein the first transmission member further includes a first driving cam, the second transmission member further includes a second driving cam, and the pushing member has a first driven cam and a second driven cam, and wherein the first driving cam is slidably sleeved on the first shaft along the first axis, is connected to the first bending plate, and cooperates with the first driven cam, and the second driving cam is slidably sleeved on the second shaft along the second axis, is connected to the second bending plate, and cooperates with the second driven cam.

8. The foldable electronic device of claim 7, wherein the pivot module includes a fixed base, a first shaft hole and a second shaft hole, wherein the fixed base has a first wing portion and a second wing portion, wherein the first shaft hole is formed through the first wing portion along the first axis, and the first shaft passes through the first shaft hole, and wherein the second shaft hole is formed through the second wing portion along the second axis, and the second shaft passes through the second shaft hole.

9. The foldable electronic device of claim 8, wherein the first driven cam is sleeved on the first shaft, the second driven cam is sleeved on the second shaft, the first driving cam is mutually matched and engaged with the first driven cam, the second driving cam is mutually matched and engaged with the second driven cam, the elastic module further includes a first elastic member and a second elastic member, the first elastic member and the second elastic member are respectively sleeved on the first shaft and the second shaft, two ends of the first elastic member respectively abut against the first wing portion and the first driven cam, two ends of the second elastic member respectively abut against the second wing portion and the second driven cam, wherein when the first panel body and the second panel body are in a half-folded state between the unfolded state and the folded state, the first driving cam and the second driving cam abut against the first driven cam and the second driven cam, whereby the first elastic member and the second elastic member are compressed, and wherein when the first carrying member and the second carrying member are in the unfolded state or the folded state, the first elastic member and the second elastic member are correspondingly released.

10. The foldable electronic device of claim 9, wherein the first axis, the first inner virtual axis, the first outer virtual axis, the second axis, the second inner virtual axis and the second outer virtual axis are parallel to one another.

11. The foldable electronic device of claim 1, wherein the synchronization module further includes a first helical protrusion, a second helical protrusion, a first helical groove and a second helical groove, and wherein the first helical protrusion is matched with and accommodated in the first helical groove, and the second helical protrusion is matched with and accommodated in the second helical groove.

12. The foldable electronic device of claim 11, wherein the first helical groove is recessed and formed on the first transmission member along a first helical direction, the second helical groove is recessed and formed on the second transmission member along a second helical direction, the second helical groove corresponds to the first helical groove, and the first helical protrusion and the second helical protrusion are respectively formed on opposite side surfaces of the synchronization slider body.

13. The foldable electronic device of claim 12, wherein the first helical direction is opposite to the second helical direction.

14. The foldable electronic device of claim 13, wherein the central base further includes a housing, and the housing covers the body portion, wherein when the first panel body and the second panel body are in the unfolded state, the first drop plate and the second drop plate contact a top side of the housing, and wherein when the first panel body and the second panel body are in the folded state, the first drop plate and the second drop plate are away from the housing.

15. The foldable electronic device of claim 14, wherein the central base further includes a track groove formed through the track portion, and wherein the synchronization module further includes a limiting rib formed on the synchronization slider body, and the limiting rib is able to be slidably accommodated in the track groove.
